(19) United States
(12) Patent Application Publication
(10) Pub. No.: US 2013/0010575 A1
(43) Pub. Date: Jan. 10, 2013

(54) SYSTEMS AND METHODS OF MANAGING ELECTRONIC CALENDAR APPLICATIONS

(75) Inventors: Jenny Jing He, Eastleigh (GB); John Arnold Owen, Eastleigh (GB)

(73) Assignee: INTERNATIONAL BUSINESS MACHINES CORPORATION, Armonk, NY (US)

(21) Appl. No.: 13/177,807

(22) Filed: Jul. 7, 2011

(51) Int. Cl. G04B 47/00

(52) U.S. Cl. 368/10

(57) ABSTRACT

Described are systems and methods for reminding a user of a scheduled repeating event. A repeating event schedule record is generated in a calendar application corresponding to a repeating event. A reminder record is generated to inform a user of an approaching end of the repeating event. The repeating event schedule record is configured to include a link to the reminder record. The reminder record is accessed in response to the link being selected.

### TECHNICAL FIELD

The present inventive concepts relate generally to computer-implemented calendar applications, and more specifically, to systems and methods for reminding a user to schedule a repeating event in an application.

### BACKGROUND

Calendar applications such as those found in Lotus Notes® by IBM, Inc. are well-known organizational tools for business users. One popular feature is that a user can schedule meetings, appointments, tasks, or other events on a recurring basis, for example, every Monday from 1-2 p.m. between January 1 and December 31 for a current year. As the end of the series of scheduled events approaches, a meeting organizer may desire to extend the recurrence of the events beyond the currently scheduled end date, for example, beyond December 31 of the current year.

### BRIEF SUMMARY

In one aspect, a computer-implemented method for reminding a user of a scheduled repeating event is provided. The method includes generating a repeating event schedule record in a calendar application corresponding to a repeating event. The method includes generating a reminder record to inform a user of an approaching end of the repeating event. The method includes configuring the repeating event schedule record to include a link to the reminder record. The method includes and accessing the reminder record in response to the link being selected.

In another aspect, a computer-implemented method for reminding a user of a scheduled repeating event is provided. The method includes generating a first repeating event schedule record in a calendar application corresponding to a repeating event. The method includes generating a reminder record to inform a user of an approaching end of the repeating event. The method includes configuring the repeating event schedule record to include a reminder completion field indicating whether a second repeating event schedule record is generated.

In another aspect, a computer program product for reminding a user of a scheduled repeating event is provided. The computer program product comprises a computer readable storage medium having computer readable program code embodied therewith. The computer readable program code comprises computer readable program code configured to generate a repeating event schedule record in a calendar application corresponding to a repeating event, computer readable program code configured to generate a reminder record to inform a user of an approaching end of the repeating event, computer readable program code configured to configure the repeating event schedule record to include a link to the reminder record, and computer readable program code configured to access the reminder record in response to the link being selected.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a computer system representative of a hardware environment in which the present inventive concepts can be implemented;

FIG. 2 is a flowchart illustrating a method for performing reminder-related actions in a calendar application, in accordance with an embodiment; and

FIGS. 3-8 are screenshots of computer-implemented calendar application features, which are constructed and operative in accordance with an embodiment.

### DETAILED DESCRIPTION

In the following description, specific details are set forth although it should be appreciated by one of ordinary skill that the systems and methods can be practiced without at least some of the details. In some instances, known features or processes are not described in detail so as not to obscure the present invention.

The present inventive concepts overcome limitations regarding conventional approaches for reminding a user that an end of a scheduled repeating calendar event, for example, the last of a series of scheduled meetings, is approaching. One conventional approach is for an event organizer such as a meeting chair to provide a personal reminder in the form of handwritten notes and the like that a currently scheduled series of events is ending and that a new repeating event is required. However, this can be difficult, since the currently scheduled series of events may have been set up many months earlier, and the meeting chair may not be aware of the date or time of the last event in the currently scheduled series of events without referring to the calendar.

Another approach is for the meeting chair to create an electronic reminder. Here, the meeting chair can create a reminder that is entered as a task into the electronic calendar. The task can be configured to coincide with the penultimate or last event in the currently scheduled series. However, the meeting chair must create the task as a separate calendar entry, which is independent of the event schedule. In order for the task to be configured as a reminder, the meeting chair must know the date and time of the penultimate or last event. Accordingly, since there is no link between the repeating event schedule and the reminder task, the meeting chair must rely on personal knowledge to configure the task to coincide with the end of the currently scheduled series of events.

In brief overview, systems and methods of the present inventive concepts are provided for performing reminder-related actions when a repeating calendar event, also referred to as a recurring event, is approaching a scheduled end. A user can create a repeating event schedule which is configured as a calendar entry or record in an electronic calendar application, email application, scheduling package, or any other application that includes scheduling features. The user can also create a reminder record to notify the user when the repeating calendar event is approaching a scheduled end. The reminder record can be configured in a format readily available for a calendar application, email application, and the like. For example, the reminder can be configured as a task record which appears in the user's electronic calendar. The start date of the task can be the user-specified reminder date and the end date can be the date of the last event in the repeating event schedule.

The repeating event schedule record can include a link to the reminder record, so that the reminder record is automatically displayed when selecting the link. The reminder record can also include a button, tab, link, and the like, which when selected can automatically populate a new repeating event schedule with event-related parameters.

The repeating event schedule record can also include a reminder completion field, also referred to as a “reminder has been actioned” field, which when selected indicates that the user has acted on the reminder, for example, the user has scheduled a new repeating calendar event. Here, the reminder record can have a status field that is updated to indicate that the reminder is complete, informing the user that a new repeating event schedule record has been generated. For example, when the reminder is configured as a task record for addition to a calendar application, the task can be removed from the user's task view in the application. In another example, email reminders can be removed from an email application's user inbox.

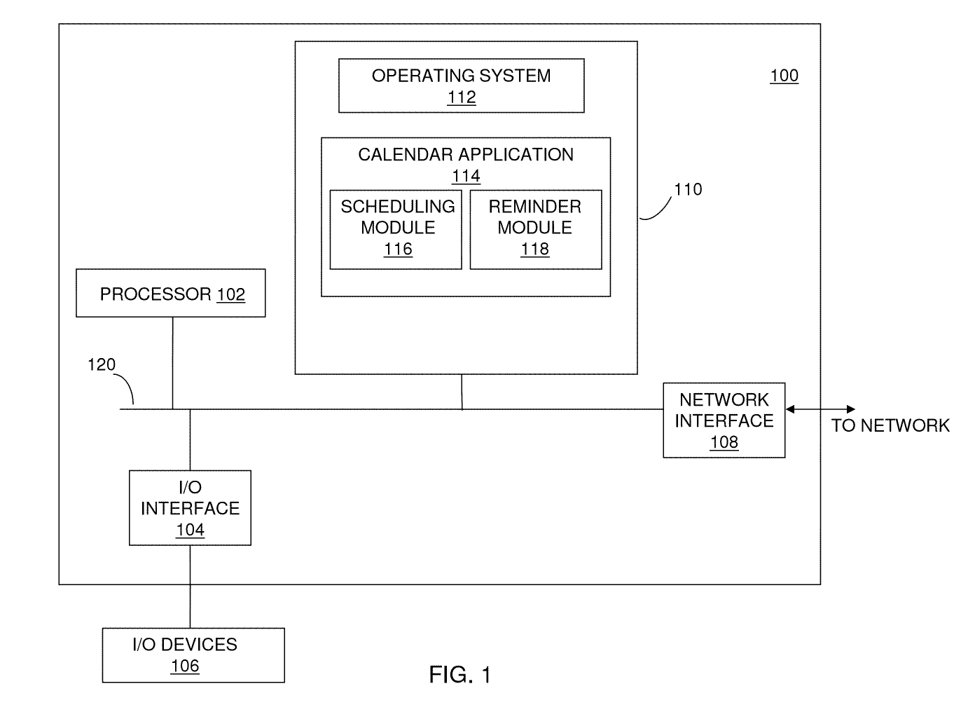

FIG. 1 is a block diagram of a computer system 100 representative of a hardware environment in which the present inventive concepts can be implemented. The computer system 100 can be a personal computer, server, smartphone, or any other electronic device known to those of ordinary skill in the art.

The computer system 100 includes, but is not limited to, at least one processor 102, for example, a CPU, an I/O interface 104, a network interface 108, and a memory 110 in communication with each other via a system bus 120.

The I/O interface 104 can be in communication with one or more I/O devices 106, such as a keyboard, a mouse, and/or a trackball, and a display, for example, a monitor or a touchscreen.

The network interface 108 can include one or more adaptors for communicating with other electronic devices via a network (not shown) such as a WAN, LAN, Internet, public network, private network, and the like, or via a direct connection.

The memory 110 can include volatile memory, for example, RAM and the like, and/or non-volatile memory, for example, ROM, flash memory, and the like. The memory 104 can include removable and/or non-removable storage media implemented in accordance with methods and technologies known to those of ordinary skill in the art for storing data. Stored in the memory 104 can include program code, such as program code corresponding to an operating system 112 and a calendar application 114. The operating system 112 is executed by the processor 102, and controls the functions of the various components of the computer system 100. The operating system 112 can be a commercially-available operating system such as Linux, Windows, and the like.

The calendar application 114 includes a scheduling module 116 and a reminder module 118. The scheduling module 116 permits a user to schedule a series of repeating events, i.e., a repeating calendar event, in accordance with embodiments referred to herein. The reminder module 118 permits a repeating calendar event to be configured with a reminder that the user is approaching the end of the repeating event schedule, in accordance with embodiments referred to herein.

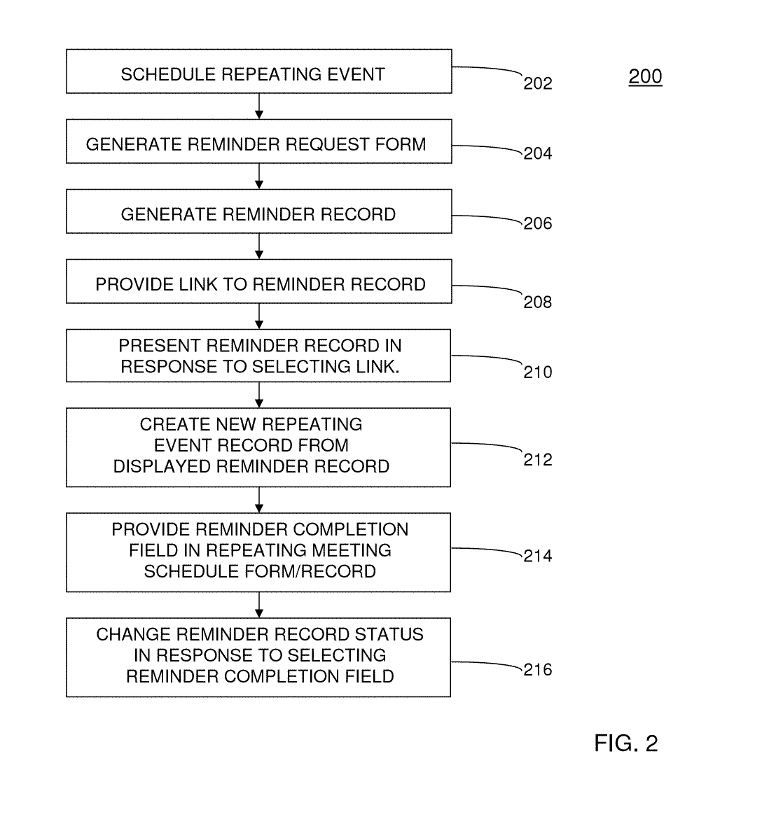

FIG. 2 is a flowchart illustrating a method 200 for performing reminder-related actions in a calendar application, in accordance with an embodiment. In describing the method 200, reference is also made to FIG. 1. The method 200 can be governed by instructions that are stored in the memory device 110 and can be executed by the processor 102 of the computer system 100.

At block 202, a repeating calendar event can be scheduled, for example, from the scheduling module 116 of the calendar application 114. A repeating calendar event can include a series of one or more meetings, appointments, activities, tasks, or other calendar events that are repeated according to a predetermined pattern, for example, daily, weekly, etc. A repeating event can be generated as a calendar entry, referred to as a repeating event schedule record, when a user completes a repeating event schedule form electronically presented to the user in a window, box, and the like at a computer display. The repeating event schedule form can include a reminder request window, prompting a user to select whether to generate a reminder that the scheduled repeating calendar event is approaching an end of its scheduled range.

At block 204, a reminder request form can be generated, for example, by the reminder module 118, when the user instructs the reminder module 118 to generate a reminder record via the reminder request window. The reminder request form can be presented to the user in a window, box, and the like from a computer display.

At block 206, a reminder record can be generated by the user inserting reminder parameters into fields of the reminder request form. Parameters can include a date and time when the user is to receive the reminder, a date and time as to when an action must be taken with regard to scheduling a new repeating event, and other relevant information.

At block 208, a link to the reminder record can be configured in the repeating event schedule record. The link can be a button, hyperlink or other well-known connector that allow a user to access one record from another record from a graphical user interface or related display.

At block 210, the reminder record can be presented on a computer display, for example, in response to selecting the link displayed from the repeating event schedule record.

At block 212, a new repeating event schedule record can be created from the displayed reminder record. The reminder record can include a link, button, and the like, which when clicked automatically populates a new repeating event schedule with data such as a headline, description, time, event recipients, and the like. This data can be received from a record corresponding to a last event of the original repeating event schedule. Other data can include a repeating instance, for example, every Monday, which can likewise be received from the original repeating event schedule. Other data can include a date range for the event schedule from the day after the original event scheduled end date, for example, December 31+1 day=January 1 next year, which can be further configured for the same duration as the original event schedule. For example, an end date, e.g. December 31 minus a start date, e.g., January 1, equals a 1 year duration.

When the new repeating event schedule is saved, the reminder record can be populated with the link to the newly created set of repeating events and automatically completed or saved depending on the reminder type. As such, the reminder record no longer appears in the user's view, for example, a task view, calendar view, email view, and the like.

At block 214, a reminder completion field, also referred to as “reminder has been actioned” is provided in the repeating event schedule record. When selected, the reminder completion field indicates that the user has received the reminder and has acted on the reminder, for example, the user has scheduled a new repeating event schedule.

At block 216, the reminder record can be changed to reflect a new status, namely, a status indicating that the reminder has been completed. Here, the reminder record can be automatically updated to indicate that the reminder has been completed, for example, that the new repeating event has been scheduled in the calendar application. The reminder module 118 can prevent future unnecessary reminders from being provided to the user.

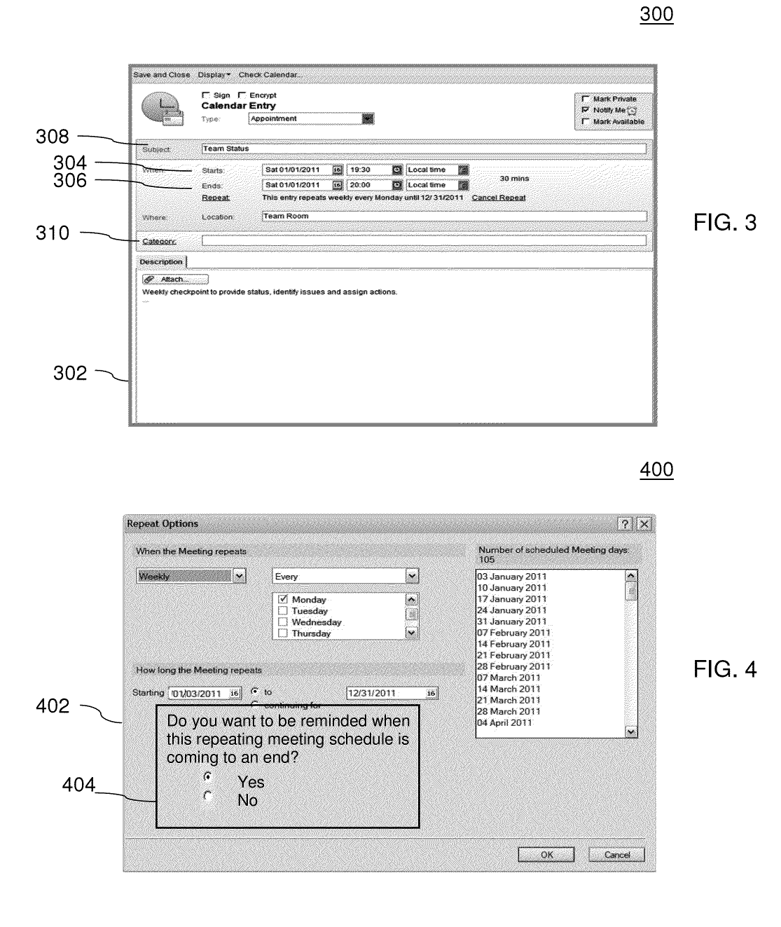

FIGS. 3-8 are screenshots of computer-implemented calendar application features, which are constructed, displayed, and operative in accordance with an embodiment. The calendar application features described with reference to FIGS. 3-8 can be displayed on a computer screen from a user interface of a calendar application, email application, scheduling application, and the like.

FIG. 3 is a screenshot of a calendar entry 300 for a repeating event, in accordance with an embodiment. A window 302 is displayed that presents the calendar entry 300 in which parameters corresponding to the repeating event can be entered. Parameters can be readily known to those of ordinary skill in the art such as a start time and date 304 and an end time and date 306 of the first scheduled event, a subject line 308, and the like. In a preferred embodiment, the calendar entry 300 includes a repeat meeting parameter 310. A user can select a link, button, and the like corresponding to the repeat meeting parameter to access a repeating event schedule form.

FIG. 4 is a screenshot of a repeating event schedule form 400, in accordance with an embodiment. A window 402 is displayed that includes a set of repeating schedule configuration options. As shown in FIG. 4, a meeting is scheduled to take place every Monday from 1/3/2011 to 12/31/2011. In an embodiment, a reminder request window 404 is also displayed, providing an attribute which requests if the user wishes to receive a reminder. The user can make a selection in the reminder request window 402 by selecting a button, link, icon, or other selection indicator.

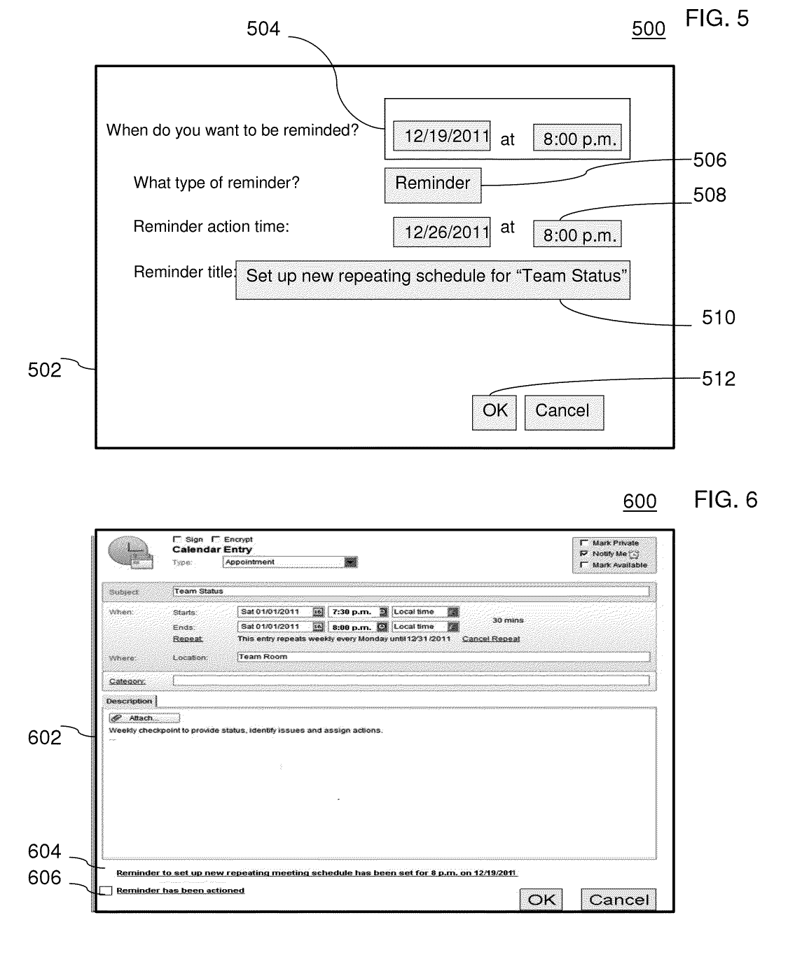

FIG. 5 is a screenshot of a reminder request form 500, in accordance with an embodiment. The reminder request form 500 can be displayed in a window 502 when the user elects to receive a reminder, for example, by selecting the “Yes” option shown in the reminder request window 402. The reminder request form 500 can include a plurality of user-configurable fields, including a reminder time/date field 504, a type of reminder field 506, a reminder action time/date field 508, and/or a reminder title field 510. The remainder time/date field 504 can be configured for a default date and/or time, for example, configured to correspond with the end time and date of the penultimate event defined in the repeating event schedule. The type of reminder field 506 can have pre-determined options, for example, Email, Task, Reminder, and the like, and can be configured to display a default type, for example, Task. The reminder action time/date field 508 can be configured for a default date and/or time of the last or final event defined in the repeating event schedule. The reminder title field 510 can include a default title, for example, “Set up new repeating schedule . . . ” When a user selects the OK button 512, a reminder record is created in accordance with the data provided in the form fields. In the example shown in FIG. 5, a reminder is scheduled for 12/19/2011 at 8 p.m. when the user selects the OK button 512.

FIG. 6 is a screenshot of a calendar entry 600 corresponding to a repeating event, in accordance with an embodiment. The calendar entry 600 can be displayed in a window 602 for presenting a repeating event schedule record having a link 604 to a reminder record created from the reminder request form 500. The repeating event schedule record can also include a reminder has been actioned field 606.

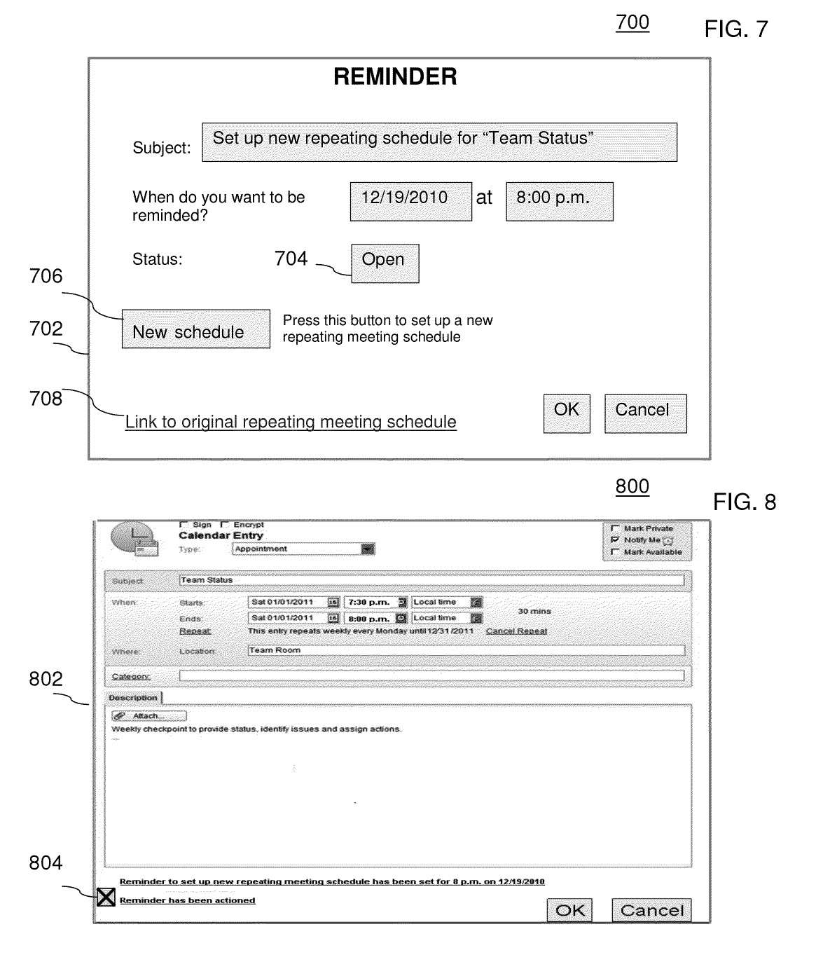

FIG. 7 is a screenshot of a reminder record 700, in accordance with an embodiment. The reminder record 700 can be displayed in a window 702. The reminder record 700 can include a status field 704 that displays the status of the reminder regarding whether a new repeating meeting is scheduled. When the status is “Open” as shown in FIG. 7, a new repeating meeting has not been scheduled. The status can be changed to “Complete” when the reminder completion field 606 shown in FIG. 6 is selected. This status can indicate that a new repeating meeting has been scheduled and that no further reminder is necessary.

The new schedule button/link 706 when selected permits the user to create a new repeating meeting schedule as described herein. The new repeating meeting schedule can be populated with parameters and other data that is the same as that used to configure an original repeating meeting schedule. A link 708 to the original repeating meeting schedule can also be displayed. When selected, the displayed original repeating meeting schedule can provide default settings for the new repeating meeting schedule.

FIG. 8 is a screenshot of a calendar entry 600 corresponding to a repeating event, where the reminder has been actioned attribute box 804 is identified as being activated, in accordance with an embodiment. The attribute box 804 can be set automatically when the new repeating meeting is scheduled, for example, corresponding to the “Complete” status described in FIG. 6. Alternatively, the attribute box 804 can be manually set by a user if the user schedules the new repeating meeting independently, for example, without checking the new schedule box 706 shown in FIG. 7. Here, the status field 704 can be updated to indicate a Complete status as shown in FIG. 7.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific embodiments, it should be understood by those skilled in the art that various changes in form and detail may be made therein without departing from the spirit and scope of the invention.

What is claimed is:

1. A computer-implemented method for reminding a user of a scheduled repeating event, comprising:
generating a repeating event schedule record in a calendar application corresponding to a repeating event;
generating a reminder record to inform a user of an approaching end of the repeating event;
configuring the repeating event schedule record to include a link to the reminder record; and
accessing the reminder record in response to the link being selected.

2. The computer-implemented method of claim 1, wherein generating the reminder record comprises:
providing a repeating event schedule form for scheduling the repeating event;
selecting from the repeating event schedule form a reminder request;
displaying a reminder request form in the calendar application when a response is received to the reminder request; and
generating the reminder record from the reminder request form.

3. The computer-implemented method of claim 2, wherein the reminder request form includes a field for entering a user-selectable time for providing a reminder to the user.

4. The computer-implemented method of claim 3, wherein the user-selectable time can be at least one of a date and a time of day up to the end of the scheduled range of time.

5. The computer-implemented method of claim 3, wherein the reminder request is configured to have a default time that is the same as an end time of a penultimate event or a last event of the repeating event.

6. The computer-implemented method of claim 1 further comprising:
configuring the repeating event schedule record to include a user-selectable field indicating whether a new repeating event schedule record is generated.

7. The computer-implemented method of claim 6, further comprising updating a reminder status in the reminder record to indicate that the new repeating event schedule record is generated.

8. The computer-implemented method of claim 1, further comprising:
generating a new repeating event schedule record from the reminder record.

9. The computer-implemented method of claim 8, wherein the new repeating event schedule record is populated with default data received from the repeating event schedule record.

10. A computer-implemented method for reminding a user of a scheduled repeating event, comprising:
generating a first repeating event schedule record in a calendar application corresponding to a repeating event;
generating a reminder record to inform a user of an approaching end of the repeating event;
configuring the first repeating event schedule record to include a reminder completion field indicating whether a second repeating event schedule record is generated.

11. The computer-implemented method of claim 10, further comprising updating a reminder status in the reminder record to indicate that the second repeating event schedule record is generated.

12. The computer-implemented method of claim 10, wherein the reminder completion field is automatically updated to indicate that the second repeating event schedule record is generated from the reminder record.

13. The computer-implemented method of claim 10, wherein the reminder completion field is manually updated to indicate that the second repeating event schedule record is generated independently of the reminder record.

14. The computer-implemented method of claim 10, further comprising configuring the first repeating event schedule record to include a link to the reminder record.

15. The computer-implemented method of claim 10, wherein generating the reminder record comprises:
providing a repeating event schedule form for scheduling the repeating event;
selecting from the repeating event schedule form a reminder request;
displaying a reminder request form in the calendar application when a response is received to the reminder request; and
generating the reminder record from the reminder request form.

16. The computer-implemented method of claim 15, wherein the reminder request form includes a field for entering a user-selectable time for providing a reminder to the user.

17. The computer-implemented method of claim 16, wherein the user-selectable time can be at least one of a date and a time of day up to the end of the scheduled range of time.

18. The computer-implemented method of claim 16, wherein the reminder request is configured to have a default time that is the same as an end time of a penultimate event or a last event of the repeating event.

19. A computer program product for reminding a user of a scheduled repeating event, the computer program product comprising:
a computer readable storage medium having computer readable program code embodied therewith, the computer readable program code comprising;
computer readable program code configured to generate a repeating event schedule record in a calendar application corresponding to a repeating event;
computer readable program code configured to generate a reminder record to inform a user of an approaching end of the repeating event;
computer readable program code configured to configure the repeating event schedule record to include a link to the reminder record;;
computer readable program code configured to access the reminder record in response to the link being selected.
